(19) United States
(12) Patent Application Publication
(10) Pub. No.: US 2023/0267342 A1
(43) Pub. Date: Aug. 24, 2023

(54) ITERATIVE ANSWER AND SUPPLEMENTAL INFORMATION EXTRACTION FOR MACHINE READING COMPREHENSION

(71) Applicant: International Business Machines Corporation, Armonk, NY (US)

(72) Inventors: Sahil Bansal, New Delhi (IN); Raunak Sinha, Greater Noida (IN); Seema Nagar, Bangalore (IN); Atul Kumar, Bangalore (IN)

(21) Appl. No.: 17/678,275

(22) Filed: Feb. 23, 2022

(51) Int. Cl. G06N 5/04

(52) U.S. Cl. CPC G06N 5/04

(57) ABSTRACT

Methods, systems, and computer program products for iterative answer and supplemental information extraction for machine reading comprehension are provided herein. A computer-implemented method includes obtaining a user query and items of context information related to the user query; identifying at least one of the items of context information to be used in connection with generating supplemental information by processing the user query and at least a portion of the multiple items of context information; generating the answer using an artificial intelligence-based question answering system; generating a modified version of the user query based on keywords derived from the generated answer and keywords derived from the user query; generating items of supplemental information for the generated answer by processing the modified version of the user query and the at least one identified item of context information; and performing automated actions based on the items of supplemental information.

### BACKGROUND

The present application generally relates to information technology and, more particularly, to data processing techniques. More specifically, conventional question-answering (QA) systems do not provide supporting facts and/or evidence to recommended answer. As a result, in many instances, answers recommended by conventional QA systems contain insufficient context, rendering such answers difficult to understand and/or process by users.

### SUMMARY

In at least one embodiment, techniques for iterative answer and supplemental information extraction for machine reading comprehension are provided. An example computer-implemented method can include obtaining a user query and multiple items of context information related to the user query, and identifying at least one of the multiple items of context information to be used in connection with generating supplemental information for an answer to the user query by processing the user query and at least a portion of the multiple items of context information. The method also includes generating the answer to the user query using at least one artificial intelligence-based question answering system, and generating at least one modified version of the user query based at least in part on one or more keywords derived from the generated answer and one or more keywords derived from the user query. Further, the method includes generating one or more items of supplemental information for the generated answer by processing the at least one modified version of the user query and at least a portion of the at least one identified item of context information, and performing one or more automated actions based at least in part on the one or more items of supplemental information.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an example embodiment of the invention;

FIG. 2 is a flow diagram illustrating techniques according to an example embodiment of the invention;

FIG. 3 is a system diagram of an example computer system on which at least one embodiment of the invention can be implemented;

FIG. 4 depicts a cloud computing environment according to an example embodiment of the invention; and

FIG. 5 depicts abstraction model layers according to an example embodiment of the invention.

### DETAILED DESCRIPTION

As described herein, at least one embodiment includes iterative answer and supplemental information extraction for machine reading comprehension. Such an embodiment can include automatically generating and/or extracting an answer and one or more corresponding items of supplemental information from a given context (e.g., text passages, documents, etc.) in response to a user-provided non-factoid query. By way merely of illustration, examples of non-factoid questions can include: “How do I separate hydrogen molecules from water?” “How do I cook hamburgers?” and “How do I fix a leak in a faucet?” As used herein, non-factoid questions refer to open-ended questions that can potentially require complex answers, including descriptions, opinions, and/or explanations, which can include passage-level texts.

More specifically, one or more embodiments include extracting answer spans from ranked passages and/or documents using at least one supervised span-selection technique and one or more passage and/or document ranker techniques. As used herein, a span refers to an inline portion of a document, wherein a starting word and an end word are marked. Further, such an embodiment includes determining and/or identifying supporting supplemental information (to a generated answer) using at least one iterative unsupervised extraction technique that targets missing information in subsequent iterations.

Accordingly, at least one embodiment includes performing supplemental information extraction in an unsupervised manner for at least one machine reading comprehension setting wherein the supplemental information granularity is not predefined. Additionally, such an embodiment need not rely on structured databases and/or knowledge graphs for extracting answers or supplemental information. By way of example, at least one illustrative embodiment can include, given a context (C) (e.g., a passage and/or document) and a non-factoid user query (Q), generating and/or extracting an answer (A) in response to the query (Q) as well as generating and/or extracting one or more items of supporting supplemental information from the passage and/or document (i.e., from the context (C)). In such an embodiment, generating and/or extracting the answer to the query can include implementing and/or utilizing supervision in terms of (C, Q, A) triplets, while generating and/or extracting the supplemental information extraction can be performed in an iterative unsupervised manner. Supervision, in this context, refers to learning and/or training a question answering model using labelled data; that is, from C, for question Q, A is the answer. More specifically, the input to the model is C and Q, and the output is A. Given a sufficient amount of such triplets, a question answering model can be learned and/or trained.

For example, in one or more embodiments, training a question answering model can include implementing the following algorithm. As noted above, such an algorithm includes using labelled data (C, Q, A), wherein (C, Q) is the input and the output produced is A, and at least one machine learning or deep learning model is used to learn from such labelled data. By way merely of example, such an embodiment can include using an encoding layer, such as bidirectional encoder representations from transformers (BERT), to encode C and Q together, and then this representation is fed to one or more deep neural network layers and further decoding is carried out to produce the answer.

Further, consider an example of iterative retrieval of supplemental information using an artificial intelligence-based QA system, wherein the question or query posed by a user is “How do I separate hydrogen molecules from water?” The answer generated by the artificial intelligence-based QA system is “Electrolysis.” Accordingly, at least one embodiment includes combining supplement generation and question answering. By way of example, in a first iteration, an artificial intelligence-based QA system is used to generate an answer to a first question. In the next iteration, such an embodiment includes preparing a new second question, wherein the new second query contains keywords from the first question and the answer. The artificial intelligence-based QA system is again queried to generate an answer for this new second question, and the answer to the second question becomes a supplement to the answer to the first question. If all keywords pertaining to the first question are covered by the second answer, then no more iterations are carried out; otherwise, a new third question is formed by retaining only the keywords which are not yet present in any of the answers, and the process repeats accordingly.

Referring again to the example in the previous paragraph, in at least one embodiment, keywords processed and/or generated by the artificial intelligence-based QA system can include “separate,” “hydrogen,” “molecules,” “water,” and “electrolysis.” Accordingly, supporting supplemental information for the above-noted answer can include, for example, information such as “There are numerous methods to produce hydrogen gas from water molecules,” and “2H2O (l) - electrolysis ➔ 2H2 (g) + O2 (g).” Additional supporting supplemental information might also include:

First, suspend two test tubes full of water upside-down in a beaker filled with water (be careful not to let any air get in the test tube). Second, put a copper wire into each test tube and have the wire run over the side of the beaker (make sure that the copper wire does not touch the bottom of the beaker). Finally, attach one copper wire to the positive side of a 9-volt battery and the other wire to the negative side of the 9-volt battery and leave overnight. The test tube that has the most gas is the test tube with hydrogen gas, and the other test tube has oxygen gas.

In connection with the above example, using the first answer and the initial query, the following QA keywords can be extracted: separate, hydrogen, molecules, water, gas, oxygen, and electrolysis. The keywords, as part of a second query, are then fed to the QA system to obtain an answer, which serves as a first supplement (to the initial answer). However, in this first supplement, not all of the keywords are present. As such, a new (third) query is created, which includes the remaining keywords.

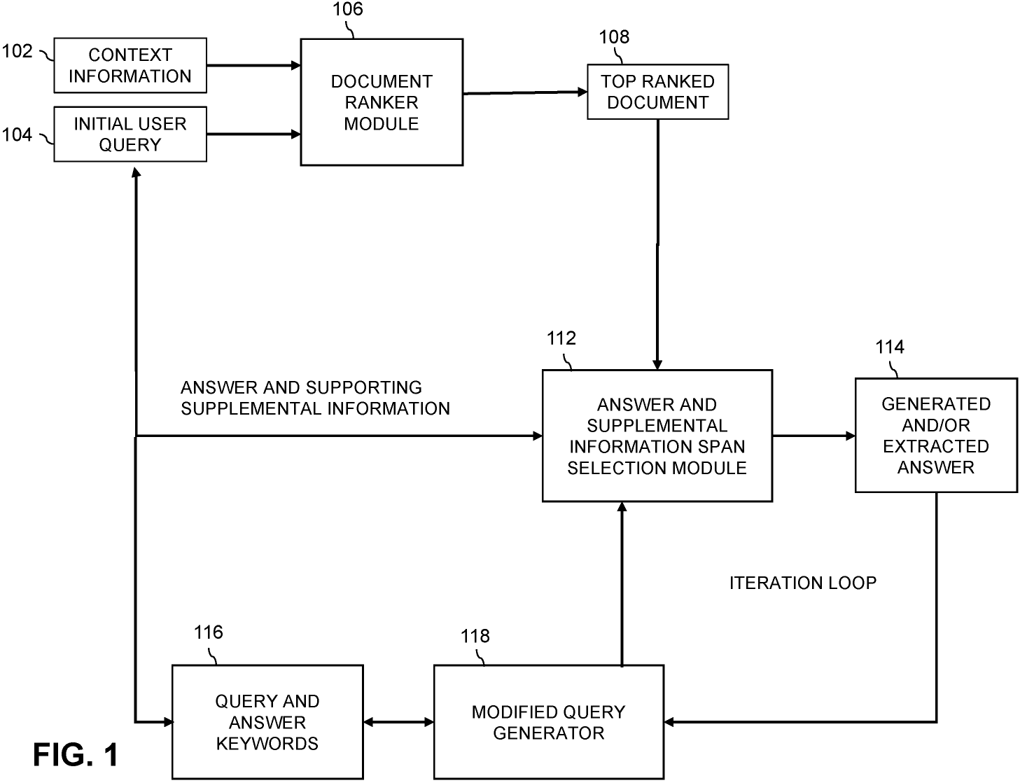

FIG. 1 is a diagram illustrating system architecture, according to an embodiment of the invention. By way of illustration, FIG. 1 depicts context information 102 (which can include, e.g., one or more documents), and an initial user query 104, both of which are provided to and/or processed by document ranker module 106. In one or more embodiments, document ranker module 106 can include one or more document ranking algorithms wherein, given a set of documents, the module ranks the documents based on the likelihood of an answer for a query being present in the document. Based at least in part on processing at least a portion of the context information 102 and the initial user query 104, the document ranker module 106 generates and outputs a top ranked document 108 (from the collection of documents in context information 102).

As further detailed in FIG. 1, the top ranked document 108 is then processed as part of an iteration loop, which includes processing (of the top ranked document 108) by answer and supplemental information span selection module 112, which generates and/or extracts an answer 114 (to the initial user query 104). More specifically, from the top ranked document, answer and supplemental information span selection module 112 extracts the span (i.e., the portion of the text) wherein the answer is present. Such a span selection can be carried out, for example, using at least one natural language processing model and/or one or more deep learning models (e.g., BERT).

Referring again to FIG. 1, the iteration loop continues by generating a modified query via modified query generator 118, wherein such a modified query is generated based at least in part on one or more query and answer keywords 116 (derived from initial user query 104 and answer 114). The modified query is then passed to the answer and supplemental information span selection module 112 to commence another of one or more additional iterations of the iteration loops.

In connection with one or more embodiments such as depicted in FIG. 1, the first iteration of the iteration loop generates the answer 114 to the initial user query 104, and the subsequent one or more iterations of the iteration loop generates supporting (to the answer 114) supplemental information, which can be provided (in conjunction with answer 114) to the user.

As detailed herein, one or more embodiments include extracting answer spans from ranked passages and/or documents using at least one supervised span-selection technique and one or more passage and/or document ranker techniques. Further, such an embodiment includes determining and/or identifying supporting supplemental information (to a generated answer) using at least one iterative unsupervised extraction technique that targets missing information in subsequent iterations.

With respect, for example, to answer and supplemental information span selection module 112 depicted in FIG. 1, at least one embodiment includes implementing such a module to extract answer spans from ranked passages and/or documents using span-selection methods and passage and/or document ranker techniques. Such span-selection methods can include implementing at least one supervised method which inputs and processes portions of one or more passages and/or documents as well as the user query, and outputs the starting and ending offsets for the answer. Additionally, such passage and/or document ranker techniques can include ranking portions of the passages and/or documents in terms of their probability of containing the answer. In one or more embodiments, the span-selection methods can also include selecting the starting and ending offsets for the answer from the top ranked passage and/or document, as determined by the passage and/or document ranker techniques (i.e., the passage and/or document with the highest probability of containing the answer). Such an embodiment can additionally include training and/or fine-tuning the span-selection methods using the dataset(s) under consideration.

Additionally or alternatively, one or more embodiments can include determining supporting (to a given answer) supplemental information using an iterative extraction method that targets missing information in subsequent iterations. Such an embodiment includes implementing an unsupervised method which makes use of a model trained such as detailed above in connection with the span-selection methods (i.e., trained using the dataset(s) under consideration). Such an unsupervised method follows an iterative procedure with a modified query along with portions of the passage(s) and/or document(s) being input to the model in every iteration. For every iteration, a modified query is created based at least in part on the initial user query and the supplemental information extracted in one or more previous iterations.

In at least one embodiment, the iterative procedure terminates when all of the keywords in the initial user query have appeared at least once among the extracted supplemental information. Also, in one or more embodiments, for every iteration, the modified query can be created in a manner such that the modified targets one or more initial user query terms that are not covered by existing supplemental information. A query modification step can optionally include query expansion (e.g., in a scenario wherein the query is ambiguous and/or contains insufficient information to extract appropriate supplemental information). Such query expansion can be carried out, for example, using the keywords that have appeared in the supplemental information extracted in the previous iterations.

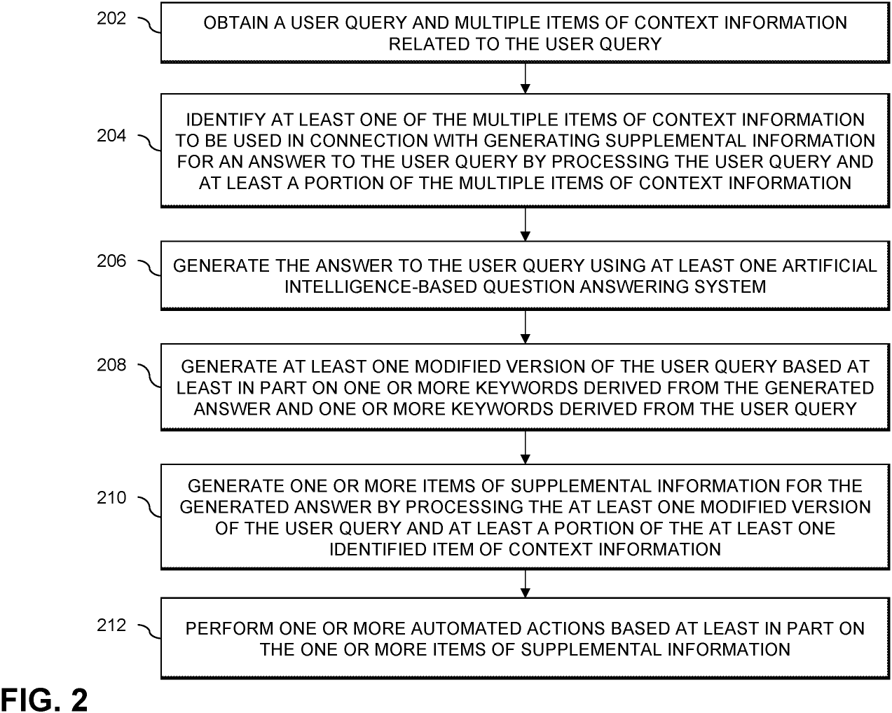

FIG. 2 is a flow diagram illustrating techniques according to an embodiment of the present invention. Step 202 includes obtaining a user query and multiple items of context information related to the user query.

Step 204 includes identifying at least one of the multiple items of context information to be used in connection with generating supplemental information for an answer to the user query by processing the user query and at least a portion of the multiple items of context information. In at least one embodiment, identifying at least one of the multiple items of context information to be used in connection with generating supplemental information for the answer includes processing the user query and at least a portion of the multiple items of context information using one or more probability-based algorithms. In such an embodiment, identifying at least one of the multiple items of context information to be used in connection with generating supplemental information for the answer can further include using one or more ranking algorithms.

Step 206 includes generating the answer to the user query using at least one artificial intelligence-based question answering system. Step 208 includes generating at least one modified version of the user query based at least in part on one or more keywords derived from the generated answer and one or more keywords derived from the user query.

Step 210 includes generating one or more items of supplemental information for the generated answer by processing the at least one modified version of the user query and at least a portion of the at least one identified item of context information. In at least one embodiment, generating one or more items of supplemental information includes using at least one supervised span-selection technique. In such an embodiment, using at least one supervised span-selection technique can include outputting at least one starting offset and at least one ending offset for the generated answer. Further, such an embodiment can include training at least one supervised span-selection technique using at least a portion of the multiple items of context information.

Additionally or alternatively, in one or more embodiments, generating one or more items of supplemental information can include using at least one iterative unsupervised extraction technique. In such an embodiment, using the at least one iterative unsupervised extraction technique includes targeting missing information across multiple iterations of implementation of the at least one iterative unsupervised extraction technique.

Step 212 includes performing one or more automated actions based at least in part on the one or more items of supplemental information. In at least one embodiment, performing one or more automated actions includes training the at least one artificial intelligence-based question answering system using at least a portion of the one or more items of supplemental information. Additionally or alternatively, performing one or more automated actions can include outputting, to at least one user associated with the user query, the generated answer and the one or more items of supplemental information.

In one or more embodiments, the techniques depicted in FIG. 2 can additionally include performing query expansion on the user query using at least a portion of the one or more keywords derived from the generated answer and at least a portion of the one or more keywords derived from the user query. Additionally or alternatively, at least one embodiment can include repeating (i) generating at least one modified version of the user query and (ii) generating one or more items of supplemental information until each keyword derived from the generated answer and each keyword derived from the user query are utilized. Also, in one or more embodiments, software implementing the techniques depicted in FIG. 2 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

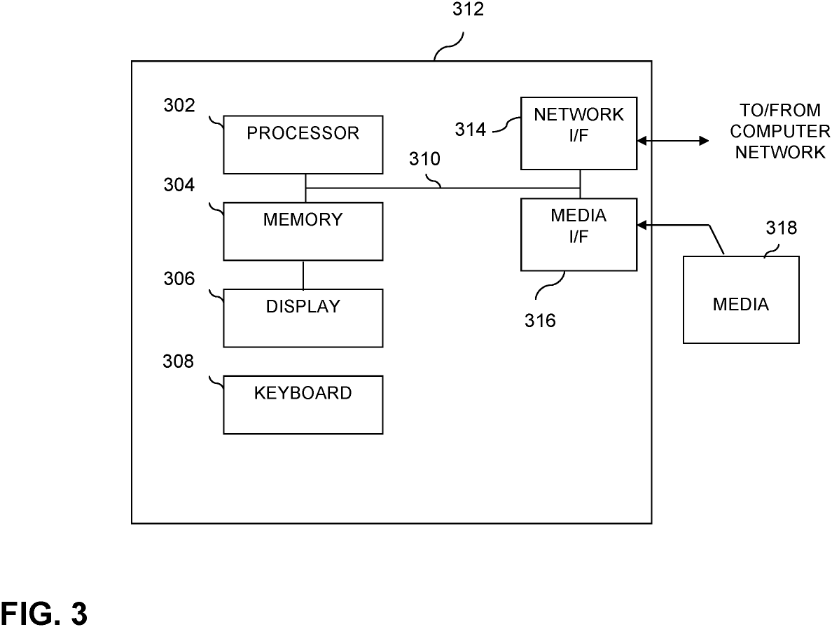

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

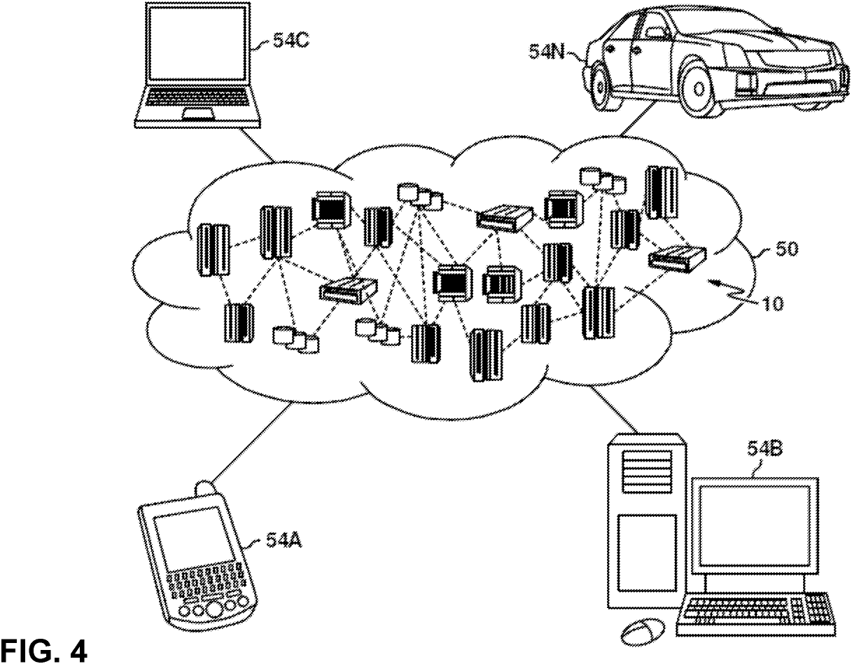

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

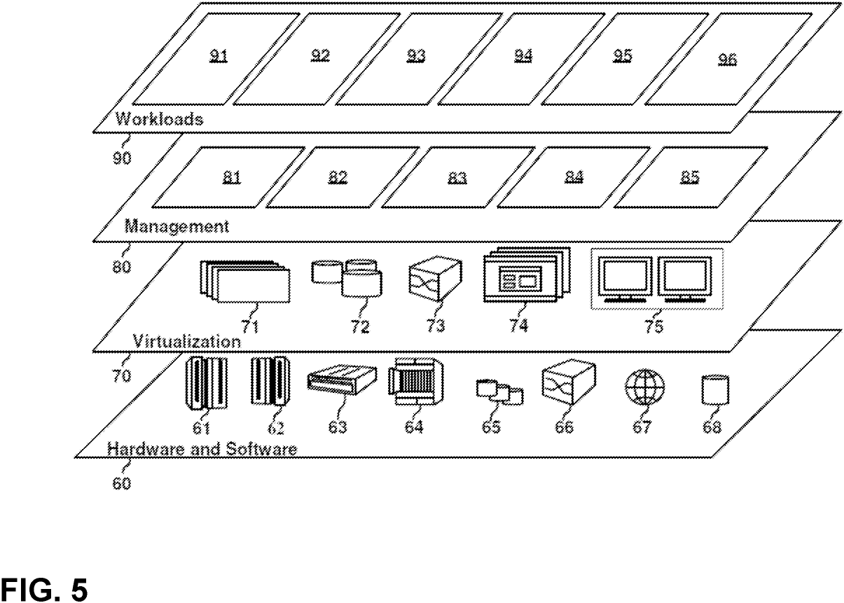

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and iterative answer and supplemental information extraction 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, implementing alignment-based iterative answer and supplemental information extraction for machine reading comprehension.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a user query and multiple items of context information related to the user query;
identifying at least one of the multiple items of context information to be used in connection with generating supplemental information for an answer to the user query by processing the user query and at least a portion of the multiple items of context information;
generating the answer to the user query using at least one artificial intelligence-based question answering system;
generating at least one modified version of the user query based at least in part on one or more keywords derived from the generated answer and one or more keywords derived from the user query;
generating one or more items of supplemental information for the generated answer by processing the at least one modified version of the user query and at least a portion of the at least one identified item of context information; and
performing one or more automated actions based at least in part on the one or more items of supplemental information;
wherein the method is carried out by at least one computing device.

2. The computer-implemented method of claim 1, wherein generating one or more items of supplemental information comprises using at least one supervised span-selection technique.

3. The computer-implemented method of claim 2, wherein using at least one supervised span-selection technique comprises outputting at least one starting offset and at least one ending offset for the generated answer.

4. The computer-implemented method of claim 2, further comprising:
training at least one supervised span-selection technique using at least a portion of the multiple items of context information.

5. The computer-implemented method of claim 1, wherein generating one or more items of supplemental information comprises using at least one iterative unsupervised extraction technique.

6. The computer-implemented method of claim 5, wherein using the at least one iterative unsupervised extraction technique comprises targeting missing information across multiple iterations of implementation of the at least one iterative unsupervised extraction technique.

7. The computer-implemented method of claim 1, wherein performing one or more automated actions comprises training the at least one artificial intelligence-based question answering system using at least a portion of the one or more items of supplemental information.

8. The computer-implemented method of claim 1, wherein performing one or more automated actions comprises outputting, to at least one user associated with the user query, the generated answer and the one or more items of supplemental information.

9. The computer-implemented method of claim 1, wherein identifying at least one of the multiple items of context information to be used in connection with generating supplemental information for the answer comprises processing the user query and at least a portion of the multiple items of context information using one or more probability-based algorithms.

10. The computer-implemented method of claim 9, wherein identifying at least one of the multiple items of context information to be used in connection with generating supplemental information for the answer further comprises using one or more ranking algorithms.

11. The computer-implemented method of claim 1, further comprising:
performing query expansion on the user query using at least a portion of the one or more keywords derived from the generated answer and at least a portion of the one or more keywords derived from the user query.

12. The computer-implemented method of claim 1, further comprising:
repeating (i) generating at least one modified version of the user query and (ii) generating one or more items of supplemental information until each keyword derived from the generated answer and each keyword derived from the user query are utilized.

13. The computer-implemented method of claim 1, wherein software implementing the method is provided as a service in a cloud environment.

14. A computer program product comprising a computer readable storage medium having program instructions embodied therewith, the program instructions executable by a computing device to cause the computing device to:
obtain a user query and multiple items of context information related to the user query;
identify at least one of the multiple items of context information to be used in connection with generating supplemental information for an answer to the user query by processing the user query and at least a portion of the multiple items of context information;
generate the answer to the user query using at least one artificial intelligence-based question answering system;
generate at least one modified version of the user query based at least in part on one or more keywords derived from the generated answer and one or more keywords derived from the user query;
generate one or more items of supplemental information for the generated answer by processing the at least one modified version of the user query and at least a portion of the at least one identified item of context information; and
perform one or more automated actions based at least in part on the one or more items of supplemental information.

15. The computer program product of claim 14, wherein generating one or more items of supplemental information comprises using at least one supervised span-selection technique, wherein using at least one supervised span-selection technique comprises outputting at least one starting offset and at least one ending offset for the generated answer.

16. The computer program product of claim 14, wherein generating one or more items of supplemental information comprises using at least one iterative unsupervised extraction technique.

17. The computer program product of claim 16, wherein using the at least one iterative unsupervised extraction technique comprises targeting missing information across multiple iterations of implementation of the at least one iterative unsupervised extraction technique.

18. The computer program product of claim 14, wherein performing one or more automated actions comprises training the at least one artificial intelligence-based question answering system using at least a portion of the one or more items of supplemental information.

19. The computer program product of claim 14, wherein performing one or more automated actions comprises outputting, to at least one user associated with the user query, the generated answer and the one or more items of supplemental information.

20. A system comprising:
a memory configured to store program instructions; and
a processor operatively coupled to the memory to execute the program instructions to:
obtain a user query and multiple items of context information related to the user query;
identify at least one of the multiple items of context information to be used in connection with generating supplemental information for an answer to the user query by processing the user query and at least a portion of the multiple items of context information;
generate the answer to the user query using at least one artificial intelligence-based question answering system;
generate at least one modified version of the user query based at least in part on one or more keywords derived from the generated answer and one or more keywords derived from the user query;
generate one or more items of supplemental information for the generated answer by processing the at least one modified version of the user query and at least a portion of the at least one identified item of context information; and
perform one or more automated actions based at least in part on the one or more items of supplemental information.
